(19) United States
(12) Patent Application Publication
(10) Pub. No.: US 2003/0044329 A1
(43) Pub. Date: Mar. 6, 2003

(54) Center for purifying, washing and treating fumes ashes

(76) Inventor: Jose Manuel Oliveira Rodrigues, Fafe (PT)

Correspondence Address: SUGHRUE MION, PLLC, 2100 Pennsylvania Avenue, NW, Washington, DC, 20037-3213, US

(21) Appl. No.: 10/262,850

(22) Filed: Oct. 3, 2002

Related U.S. Application Data
(63) Continuation of application No. PCT/PT01/00016, filed on Jul. 24, 2001.

(30) Foreign Application Priority Data
Jul. 25, 2000 (PT) 102498

(51) Int. Cl. B01D 53/34

(52) U.S. Cl. 422/168; 422/171; 422/173

(57) ABSTRACT

A center that retains, washes and treats fumes from ovens and boilers that produce dusts, dioxides, gases and other compositions. The center naturally treats the fumes by neutralizing their noxious effects, once the noxious effects are eliminated they are reduced to mud, the precipitate is a result of a number of transformations: mechanical, physical and chemical, in forced courses in the operations of the center's system and after purifying such noxious products from the fumes they are guided to a vat of additives filled with water at 100° C. therefor releasing vapor which is later used in a distillation column, the remains of the system are bacteriologically pure distilled water and mud that serve agriculture. The system may be applied in closed-in public places, cleaning the environment directly inside and making the room's atmosphere healthy and comfortable because at the same time it can also correct the room's temperature, all of this is possible in a mini-center that can be moved around.

This is a continuation of International Application No. PCT/PT01/00016 filed Jul. 24, 2001; the disclosure of which is incorporated herein by reference.

### DESCRIPTION

This invention concerns a PURIFYING STATION to be installed in furnaces, boilers and others, to be substituted in industries, any chimney, chimneyless, without discharging into the atmosphere fumes and their polluting compounds or noxious, resulting from various types of combustion.

PURIFYING STATION: not polluting the environment, the ecosystem, Man, the planet, the STATION, the system and their mechanical, physical, chemical, electronic and other components, whose aim it is to substitute chimneys, retain fumes and their polluting compounds in the STATION, transforming and neutralizing them along forced courses by system components, with special reference to the M.C. (6) components and a small tub (8) using additives and water in a vicious cycle at 100° C., as well as stable temperature, also to release steam into the distillation column (15) in order to classify the solid precipitates from the liquid or other, precipitates, residues resulting from the system's operations. A system which eliminates, neutralizes fumes and their polluting, noxious compounds such as dust particles, gases, dioxins, anhydrides and other nullified pollutants, from calcium hydroxide, amongst others, transforming them into precipitates from calcium carbonates and others, which, once reduced to solid, liquid and other residues are nullified, unpolluted and discharged to the exterior, treated, becoming biologically and ecologically usable. The solids may be used in agriculture; the liquids becoming bacteriologically pure water.

STATION which, besides eliminating fumes and other pollutants from industry resulting from various types of combustion, as well as solid, liquid, gas and other fuels, also the Station or Stations, the system, which allows for variations to be adapted and even to purify, directly or indirectly, the surrounding air in closed indoor areas, public premises, pavilions and others, and domestic areas, housing and others, cleansing the air in each area, making it healthy and comfortable, since the system is able to correct room temperature simultaneously.

PURIFYING STATION, for various capacities, uses, dimensions, forms, numbers, varied-applications and others, aiming to eliminate the discharge of fumes and other polluting compounds into the atmosphere, preventing the contamination or pollution in the atmosphere, thus reducing the greenhouse effect since, in this way, the atmospheric air is protected from pollutants in general and, more specifically, because the system which comprises this Station, besides not polluting the outside atmospheric air, directly or indirectly, cleanses the surrounding air in closed indoor areas, public premises, pavilions, hospitals, offices, and domestic, housing and others.

Thus, it eliminates pollution, either in the saturated surroundings of public and domestic areas, or others—pigsties—, others, as well as eliminates the atmospheric contamination generated by industry, fumes and their derivatives, resulting from the various types of combustion in furnaces, boilers, amongst others, so that they are not discharged into the atmosphere, because the Purifying Station retains and treats within its interior the polluting products dangerous to Man, to the environment and to the ecosystem, namely sulphurous and nitrate anhydrides, tar, dioxins, as well as carbon compounds and other pollutants, which the Station, the system after neutralizing them, transforms into calcium carbonate precipitates and others—transforms into liquid, solid and other residues, which are biologically and ecologically usable since the solids become fertilizers for agriculture and the distilled liquids become distilled water, which is bacteriologically pure.

The invention concerned, the PURIFYING STATION, a system to be installed in furnaces, boilers and others to substitute chimneys in industry, chimneyless, not discharging into the atmosphere all the polluting compounds resulting from various polluting situations, so as not to pollute, thus cleansing, the environment, Man and the ecosystem creating a means of preserving the planet.

STATION which substitutes chimneys in industry whose system's original components, mechanical, physical, chemical, electronic, amongst others, function it is to retain, eliminate polluting products, fumes and others, without discharging them into the atmosphere, since it neutralizes them without filters, reducing them to precipitates along forced courses and immediately after passing through the various system components, such as components M.C. (6) and a small tub (8) with additives dosed in water in closed circuits, its load at a temperature of 100° C., also to release steam to the distillation column (15), or, in order to classify the precipitates from the transformations, residues which may be as a solid, liquid or other, to be discharged to the exterior in unpolluted form.

Thus, the system pollutes neither the atmosphere nor the soil, in the defense of the ecosystem, Man, the planet and which, in one of its variations, also allows for the direct cleansing and purification of saturated indoor air, in closed indoor areas, both public and domestic, transforming it into cleansed, healthy as well as comfortable indoor environments, since it also simultaneously corrects room temperature in a compartment, and in each case, both as a station with vents to each area requiring cleansing, as well as a mobile mini-station.

Purifying Station, to be adapted to each situation, one or more stations to be installed, interconnected through bypass in order to activate the reserve or not, in a accordance with what is deemed technically necessary such as M.C. (6), variable in number to incorporate in one or more Stations, or other components, possibilities of the Station, in accordance with performance;

Station, system and their components, are all integrated in the automatic control through an electric and electronic control board—Q.E.C. (24), which establishes and reestablishes supplies through automatic commands, from provision and reestablishment of water and additives to maintain the compulsory levels which are automatically reestablished, as well as to discharge residues, the various types of station performance, the system and its various functions, activated as follows.

1. Preparation for the Purification of Fumes and Their Polluting Compounds:

The initiation and preparation for purification, is undertaken in a container (10), outside the Station, which is supplied with water from E-B (9) to the cistern C.G.A. (16A) and from the latter, through electrum-pump E-B (9A) equipped with a bypass for double service, or better yet, circuit 1 and 2 processed in Q.E.C. (24) which, supplies the container (10) through circuit 2, opening the pneumatic valve V.A.2 and closing valve V.A.1, then returning to circuit 1, maintaining V.A.2 closed and opening V.A.1 after the container (10) has been filled, in order to add quicklime to the latter together with water, preparing the calcium hydroxide and transforming it to paste;

a) The paste is introduced in portions through the stopper (11) in (R10A), in order to mix with the water in that cistern, pumped from the C.G.A. (16A) through the E-B (9A), circuit 1, so that this mixture, paste and water in this cistern (R10A) is stirred until it liquefies, responding to the demands, anticipating and necessarily correcting the levels of (H₂O) and Ca (OH)₂, in reserve for these demands;

b) Stirring in the (R10A) as well, to prevent inactivity during waiting time, between the mixture of Ca(OH)₂ and the demands occasionally observed by the (R10B), (R10C) and small tub (8), so that they correspond, as well as others;

c) After the activity of the stirring mechanism in the (R10A), the mixture has liquefied, the top portion consisting of water and lime in a clearer form, calcium hydroxide, Ca(OH)₂ which is then pumped by the E-B (9H) from the (R10A) to the (R10B) and from here, by the E-B (9J) to the tub (8) in response to the foreseen demands;

d) Still in these courses, before reaching the tub (8) and in the passage through (R10C), the collection, or not, of additives required in the control of ebullition of the tub (8) loaded, either with metallic zinc, or others, liquid additives being necessary for the decomposition of fumes and others required for the purifying correction in the tub (8) with its load at a stable 100° C., temperature used from the boiler's activity, or, the Purifying Station working without making use of other sources of energy; or not;

2. Treatment of Fumes:

The fumes produced by the combustion of ovens, furnaces, boilers (1), or others, are the fumes expelled from boiler (1) or, conducted by the fume vents (3) with or without heat reducers, and due to the activity of the turbine (4) these are discharged into the fume-retention column (5) with or without heat reducers. The heat may or may not be used in the preheating column (5) with one or more exits, each with an M.C. (6) and each supported by a vacuum pump (6G). The entry of air being made once again either through the pneumatic valve (6D), the opening and closing of fume suction by the M.C. (6) and filled once again, by the opening and closing of the pneumatic valve (6F) which activates the E-B (9F) to supply the M.C. (6) with liquid compounds or, from the tub (8) in a closed circuit, the liquid preparation's main reagent being calcium hydroxide and others, dosed in water at 100° C.;

a) After the M.C. (6) is completely loaded, it continues its work in order to integrate the neutralization and transformation of fumes and their noxious compounds, which pollute the atmosphere, becoming harmless to the environment, due to the action of the Station, its components, the system, the chemical, physical, mechanical, electronic and other actions, factors which interfere in the M.C. (6), to the precipitation of its entire load discharged in the vent (7) and returning to the tub (8) by opening the pneumatic valve (6E), continuing thus, successively, instantly, automatically, rhythmically, repeating the activity distributed to each M.C. (6), taking the number of M.C. (6) into consideration, one or more per Station, a number suited to the Station's functions;

b) It is these precipitates, residues, which become part of the tub (8) liquid and solid load, or others, resulting from the transformations undertaken, complemented, by the M.C. (6), then distilling, so that the fumes and their polluting compounds are no longer noxious to Man and the environment since, thus neutralized and transformed, they become residues of varied composition and are cleansed, both the liquids, solids and others, having partially become calcium carbonate precipitates. Others, the solids are used in agriculture as a nutrient or pH corrector for acid soil. The liquids, distilled, become bacteriologically pure water, and in this way, the fumes and their polluting compounds, unpolluted, transformed residues, pollute neither the atmosphere nor the soil.

3. Distillation:

From the treatment of fumes and their polluting compounds to their neutralization and cleansing it all takes place in the tub (8) at 100° C., part liquid and others, the temperature caused by the incursion in the tub (8) of the vent (3) of varying sizes, and column (5), or vents (12) and (12A) or, system components with or without reducers for the heat from the furnace, the boiler (1), heating, as well as temperature, to form steam classifying precipitates, residues which are solid, liquid, other and state of steam, which—the knob or other—of this tub conducts, either to the (4A) suction of vapors, with mechanical cooling, cold or not, as steam to the serpentine (15) or, cooled in the condenser (17), or, resulting therefore as distilled water to be deposited in the glass deposit (18), or, since distilled water contains no mineral salts, it may be used in batteries or others, which, furthermore, the tub (8) load in a vicious cycle and its liquid load, or, in dosed circuits, besides being in the form of steam, the liquid load is transformed into bacteriologically pure distilled water, even if the supply is undertaken using water of no quality, and despite the low water consumption throughout the system, it is from electrum-pump E-B (16) that the supply to container (16A) is undertaken and from here, to the general provision of each and every type of application of water in the system, which is carried out by the respective electrum-pump, E-B, which supplies the condenser (17) from E-B (16B) and in the case of cold water being required, column (19) in closed circuit, or not, makes the cooling of water possible in the condenser (17), or (4A), cold or not, causing temperature differences for the transformation, cleansing, to precipitates, residues, as well as the entire liquid, solid load, others in the tub (8), neutralized, usable due to the inventive characteristics of the Station, system described, in the neutralization of these compounds which pollute the environment, recovered to become biologically and ecologically usable and which FIG. (1) represents and illustrates.

4. Cleansing of Indoor Air in Closed Areas:

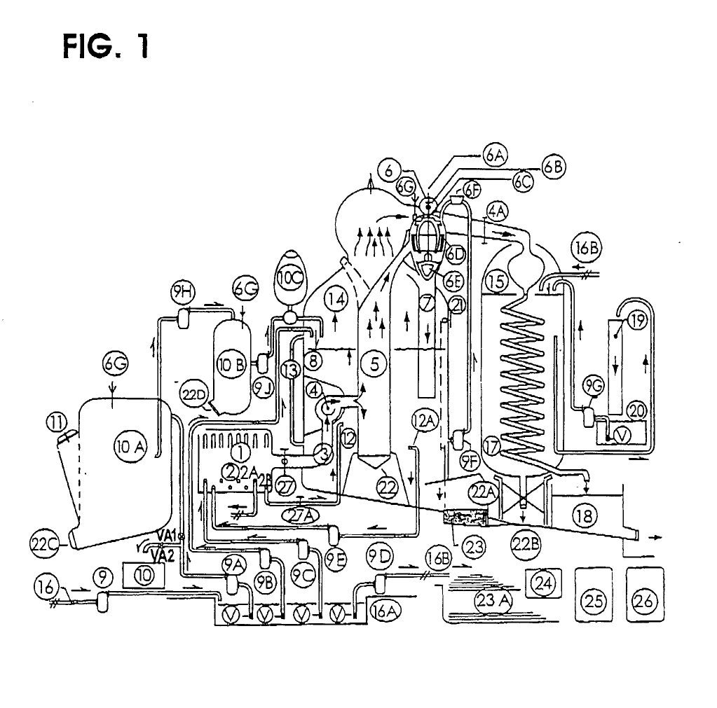

Being one of the variations of the PURIFYING STATION (FIG. 1), there is also the possibility of the cleansing variation, or the reduction or purification of polluted indoor air in closed, public or domestic areas and others, since in relation to performance, so that the Purifying Station does not pollute the exterior atmosphere with fumes and other pollutants, thus without any changes, it varies in effective application, directly or indirectly cleansing the surrounding air in closed indoor areas, which for each case, and regarding the technical adaptation required, the Stations, or, Station, merely vary in their dimensions, capacities, forms, and number of group elements interconnected with the system, or others, being thus constituted, in the same way as this one, to directly cleanse the surrounding air in closed indoor areas, public and domestic, and when there is no need for a Station with vents leading to each room requiring cleansing, the system also allows for the MINI-STATION variation, which is mobile and domestic, a small implement, which in accordance with performance variation, may be omitted or modified from the Station (FIG. 1), distillation, heat supply from boiler (1) to the heating, temperature of the tub (8) load, remaining between 20 and 30° C., the heating through electric current may even be substituted, or through the placement of resistances in the tub or mini-tub, and altering fume impulsion in turbine (4) through the suction of the air requiring cleansing in the room, variations which can be used to cleanse the air in closed indoor areas such as, pavilions, hospitals, offices, cafes, housing and other public, domestic or other premises, provided the air therein is saturated, revealing excesses of carbonic anhydride, CO2, dust particles, or others, which are unsuitable to Man due to its pollution in which the system transforms it into suitable air without the same pollution and at healthy levels;

a) To cleanse surrounding the air in closed indoor areas, and in accordance with each case, parts may be suppressed in the Station (FIG. 1), the boiler or furnace (1), the column (5), the M.C. (6), distillation, the cisterns (10A), (19B), (10C), electrum-pumps, cistern (16A) and water supply (16B), bypass, as well as the accessories (24), C25) and (26) others, (even in the case of variations, alterations regarding Station (1));

b) Variations to cleanse, or reduce pollution of the surrounding air in public, domestic and other closed indoor areas, and provided there is no need for the installation of a Station with vents to each room requiring cleansing, conditions which also include the mobile, domestic MINI-STATION, a variation simply comprising of an air suction device, which sucks in, expands and heats the air between 20 and 30° C., the heated air in the forced air circuit, due to this expansion, penetrating the load of the tub, mini-tub of 50L, or with additives dosed in water, (OH)2 Ca and other additives, at the same temperature as the air, the heating of which, as well as that of the tub and mini-tub load, is undertaken through electric resistances, controlled by thermostat at the same temperatures. These are maintained after the penetration of forced or expanded air, so as to always pass through the liquid load as well as the grill of the tub, mini-tub, until the air continuously flows out, later as cleansed air through the system and in accordance with the air suctioned in the area where such action is required;

c) In order for the user to install this MINI-STATION, all that is required is an electric current plug, using containers for the preparation of a simple mixture, the liquid load to be placed in the tub or mini-tub, the levels being visible, requiring occasional correction when deemed necessary and proceeding with the monthly, or, complete replacement of the mini-tub;

d) With this Station, or MINI-STATION installed, one can also economically improve the closed indoor area which, besides resulting in cleansed air, also benefits from improved and comfortable, enriched surroundings, even with regard to temperature, since the air circulating in each room is heated, between 20 and 30° C.;

e) It should be noted, therefore, that the cleansed and refreshed air becomes healthy, especially to Man and is even capable of attenuating allergic respiratory problems, or others;

f) Variations of the PURIFYING STATION for saturated surroundings, polluted and requiring cleansing, in closed indoor areas, the Station, using return vents of varying sections and forms, conducting air which requires cleansing from each room to the Station, variations of varying forms, dimensions, in which vents, Station, and system, proceed with the cleansing of each room, via vents for polluted air, to the posterior impulsion of the same cleansed air in the area, with occasional inverted vents in the transportation of treated and treatable surrounding air, to and from each compartment to the Station, through the tub with a load identical to tub (8), since its activity and components adjust to the neutralization of air polluting compounds, noxious to the surrounding air, to Man, purifying the surrounding air to healthy and heated levels, in the same places;

g) The residues resulting from the cleansing process, the air residues, are deposited in the load and at the bottom of the tub, or mini-tub, and are periodically retrieved, now cleansed, the same happening with the operation of the Purifying Station (FIG. 1), the same operation being extensive to all its variations and all aspects of pollution neutralization, which this invention deals with;

5. General Accessory Material:

The present invention is generally represented and illustrated by the drawing (FIG. 1), with regard to its variable-applications and, in accordance with each case, the variation in number of the referred accessories, electric and electronic accessories, mechanical and stainless steel, or others, an air and vacuum compressor (25), pneumatic valves, a reserve generator for electric energy (26) and a General Electronic Control Board (Q.E.C. 24), electrum-pumps, vents, containers, cisterns, and others, or even physical and chemical means, all, in accordance with the performance required;

### Description of Drawings (FIG. 1), Designations

1—Boiler, furnace, or combustion, varied supply;

2—Tubular serpentine, boiler;

2A—Serpentine for heating of water in boiler, services;

2B—Alternative serpentine for heating of water in tub (8), load, station;

3—Fume vent and others, various sizes, with or without heat reducers;

4—Turbine for fume impulsion, with or without heat reducers;

4A—Suction turbine for vapors, others, with mechanical cooling, cold or not;

5—Column for fume retention with one or more exits, various sizes, with or without heat reducers;

6—Central monitor (M.C.), fume treatment, temporized, one or more per Station;

6A—Electric motor with reducer, temporized;

6B—Control rod at the opening and closing of pneumatic valves for loading and unloading;

6C—Axially controlled spinning blades, or,

6D—Pneumatic valves for opening and closing, axially controlled;

6E—Pneumatic valves for opening and closing to discharge precipitates;

6F—Pneumatic valve in the passage vent and closing of (OH)2 Ca;

6G—Pneumatic valve for the entry and exit of air through vacuum in M.C. (6);

7—Precipitates column for tub (8);

8—Tub with water at 100° C. and additives, calcium hydroxide (OH)2 Ca, amongst others, and calcium carbonate CO3 Ca precipitates and others forming dischargeable residues;

9—E-B, Electrum-pump to supply water from the exterior to tank (16A);

9A—E-B, Electrum-pump to supply water from tank (16A) to the stirrer (10A) and to (10);

9B—E-B, Electrum-pump to supply water from tank (16A) to tub (8);

9C—E-B, Electrum-pump to supply water from tank (16A) to the boiler, serpentine (2);

9D—E-B, Electrum-pump to supply water from tank (16A) to the condenser;

9E—E-B, Electrum-pump to the tub (8) circuit, to the boiler through serpentine (2B);

9F—E-B, Electrum-pump to supply liquid from tub (8) to the central monitor M.C. (6);

9G—E-B, Electrum-pump to supply cold water from the tank to the condenser;

9H—E-B, Electrum-pump to supply prepared liquid from cistern (10A) to (10B);

9J—E-B, Electrum-pump to supply prepared liquid from cistern (10A) to tub (8);

10—Exterior container with quicklime, or calcium oxide and water to prepare (OH)2 Ca;

10A-R—Cistern for prepared calcium hydroxide to supply (R 10B);

10B-R—Cistern for prepared calcium hydroxide (OH)2 Ca to supply tub (8);

10C-R—Cistern for control additives, liquid or solid, for purification of tub (8);

11—Loading cover for cistern (10A);

12—and 12A—Vents for liquids from tub (8) to the boiler, or, return, circuit for preheating, or heat reducers others, temperature control for liquids in tub (8);

13—Visor for levels of liquid in tub (8);

14—Water steam-chamber, or;

15—Distillation column, serpentine condenser, or;

16—Water supply from the exterior to tank (16A);

16A—C.G.A. General supply tank for cold water,

16B—Cold water supply, from tank (16A) to the condenser;

17—Cold water for the condenser;

18—Glass, or other, cistern for distilled water;

19—Water cooling column for the condenser;

20—Tank for condenser, cooled or cold water;

21—Controlled rod, opening and closing of flaps for discharge residues, in tub (8);

22—Cleaning flap for the fume retention column (5) (opening and closing);

22A—Cleaning flap for residues in tub (8), to be continuously discharged (opening and closing);

22B—Cleaning flap for the condenser, dischargeable residues (opening and closing);

22C and 22D—Cleaning flap for calcium hydroxide cisterns;

23—Deposit for residues in tub (8), to be discharged into residue bin in the exterior (23A);

24—Q.E.C., Electric and Electronic Control Board;

25—Compressor for compressed air, pneumatic valves, others;

26—Reserve generator for electric energy;

27 and 27A—Bypass, for liquids, or for the number of one or more Stations;

V—Retention valves for E-B groups;

VA—Pneumatic valves VA1 and VA2 (controlled);

1. Purifying Station to be installed in furnaces, boilers and others, in industry to substitute any chimney, chimneyless, not discharging into the atmosphere fumes and their noxious polluting compounds, resulting from various types of combustion, whose aim it is to retain fumes and their polluting compounds within the Station which are eliminated by the Station, the system, through their mechanical, electronic, physical and chemical compounds, amongst others, integrated in this Purifying Station, in order to neutralize fumes and their polluting compounds requiring cleansing, as well as dioxins, anhydrides, gases, ashes, other polluting waste discharged into the atmosphere and resulting from the combustion of solid, liquid, gas or other fuel products, burnt in furnaces, boilers, or other forms of combustion which are polluting to the atmosphere and the environment, to be transformed by the installation of this station, or Stations which vary in number, form, size, varied-applications others, according to what is deemed technically necessary for the transformation of these pollutants by the fore mentioned components into precipitates, residues, which, after being conducted, are deposited in the liquid and solid load of the tub (8) at the bottom of this Station, or Stations, a residue deposit, neutralized from this load at 100° C., to transform into steam thus classifying the solids from the liquid portion, to be distilled by the distillation column (15), distilled water of varied applications, distillation through condenser (17), condensation of liquids and others, cooled, transformed, either cold by (4A) to be integrated or not, in the condensation of vapors, the same transformed load, thus cleansed, its solid portion applicable in agriculture, in soil, since the Station, the system, replacing and totally dispensing the classic chimney for fumes and other polluting compounds emitted into the atmosphere, which does not occur with the installation of this invention, since the Station retains and eliminates these polluting compounds without any emission into the atmosphere and transforms them, the residues of these transformations into precipitates, so that they are converted from polluting products into usable products, the solids becoming agricultural fertilizers—neutral pH—and the liquids becoming distilled water, bacteriologically pure water, which the Station, the system produces, polluting neither the atmosphere nor the soil, regardless of the type of fuel burnt, as well as its residues, made biologically and ecologically usable and, further, that the Station, Stations, the system, in one of its variations, directly or indirectly cleanses the surrounding air in closed indoor areas, characteristics of the system, of the Stations, which vary only in size, shape and others according to their purpose, and in the case of vents being unnecessary in the cleansing of saturated air from each area to the Station, returning as cleansed air, the mini-tub may be chosen, a mobile Mini-Station for each room and domestic variations, to directly cleanse surrounding air in indoor areas, from public premises, pavilions, housing and others, specifically, and generally, since the Station or Stations, succeed in reducing atmospheric pollution, dioxide or carbon monoxide and others, which, from what is observed and claimed, is vital to the environment, Man, the ecosystem, and the planet, as it reduces the greenhouse effect which pollution causes—the hole in the ozone layer;

2. Purifying Station for the treatment of fumes and their compounds which pollute the atmosphere and soil, in accordance with claim 1, characterized for possessing the M.C. (6), a central monitor, one or more per Station, or Stations, component for continuous loading and unloading through the opening and closing of pneumatic valves (6E) and (6F) controlled and served by the vent (3), turbine (4), retention column (5) with one or more exits into one or more M.C. (6) per Station, supplied by the tub (8) load and other components in closed circuit and it is in this part, the M.C. (6), that the main neutralization process occurs, the transformation of fumes and their polluting compounds from the liquid load, water and additives from tub (8) at 100° C. and during operations in this part M.C. (6), a portion of the fore mentioned reactions takes place, in accordance with the inventive conceptions of the system, the Stations, the Station (FIG. 1), transformations, to the elimination, neutralization of fumes and their polluting compounds, such as that of transforming anhydrides into acids, and the latter immediately neutralized by the base Ca(OH)2, as well as other additives in the tub (8) load, neutralization reactions which the M.C. (6) completes, later discharged into a vent (7) above the tub (8), all of these forming precipitates, insoluble residues, or liquid and others, which are deposited in the load or at the bottom of tub (8), and the precipitates, liquid residues, solids and others are neutralized and later classified through the distillation column (15) or, cooled by the condenser (17) or by cold through (4A), the liquids becoming distilled water for the glass deposit and the solids discharged through exits (21), (22), (22A), (23), or;

3. Purifying Station to neutralize fumes and their compounds which pollute the atmosphere and soil, in accordance with claim 1, characterized to eliminate the emission of industrial fumes, and their compounds which pollute the atmosphere, all of these being reduced to products which are harmless to the environment, Man and the ecosystem, since they will neither pollute the atmosphere nor the soil, because the residues are simultaneously and continuously recovered and removed, becoming usable, both in the liquid portion through permanent distillation, into distilled water, demineralized water electrolytic product, or even, bacteriologically pure water, as well as the precipitates and the residues, predominantly formed by calcareous agents, or other, solid residues being applicable to agriculture and in soils as a pH corrector and also, excessive heat from the heat reducers or not, used for preheating or not, at the boiler outlet (1) or in the vent (3), turbine (4) and in the fume retention column (5);

4. Purifying Station to neutralize fumes and their compounds which pollute the atmosphere and soil, in accordance with claim 1, characterized for preventing the emission, by industries, of these pollutants into the environment, into the atmosphere in general through the Station, the system and its variations, directly and indirectly cleansing the surrounding air in closed-indoor areas, housing, or public such as, hospitals, pavilions, amongst others, where the air is saturated and contains excessive levels of carbonic anhydride, CO2, fumes, dust, and other pollutants noxious to Man, their variations, and when there is no need for a Station with vents to each area containing polluted air, which requires cleansing, the variation mini-tub may be chosen, a mobile and domestic Mini-Station, variations for each type of performance through adjustments made to shape, capacity, size and others, through the Station, through variation, which from the Purifying Station (FIG. 1) not varying in its function, vary in each case of technical adaptation in the number of elements which interconnect with the system, differing in the increase and suppression of components in the same way that, to suppress distillation or not, and the M.C. (6), substituting the tub (8) with mini-tub of 50L, or, and its liquid load prepared with additives, and heating with the boiler (1) then being carried out by electric current to between 20 and 30° C., using thermostatically controlled resistances, changes in the impulsion of the fumes turbine (4) through the suction and impulsion of air from the room, forced air heated at the same temperature as that of the liquid load, expanded air passing through the load until it leaves the system, and in the room in a closed circuit at the same temperature, the surrounding air thus becoming cleansed in the area required and comfortable at 20 to 30° C., enriched, diminishing problems related to allergy, or, reestablishing healthy levels in the surrounding indoor air and atmospheric air, due to the extensive function of the variations, performance of the Station, Stations, the system in this case, the neutralization of these pollutants using the present invention, of Stations, Station, illustrated and represented by FIG. 1.
